(19) United States
(12) Patent Application Publication
(10) Pub. No.: US 2005/0053385 A1
(43) Pub. Date: Mar. 10, 2005

(54) Optical apparatus and optical processing method

(76) Inventors: Kosuke Nishimura, Saitama (JP); Masashi Usami, Saitama (JP)

Correspondence Address: CHRISTIE, PARKER & HALE, LLP, PO BOX 7068, PASADENA, CA, 91109-7068, US

(21) Appl. No.: 10/933,949

(22) Filed: Sep. 2, 2004

(30) Foreign Application Priority Data
Sep. 4, 2003 (JP) 2003-312473

(51) Int. Cl. H04B 10/04

(52) U.S. Cl. 398/188

(57) ABSTRACT

A first semiconductor optical amplifier is disposed on a first arm of a Mach-Zehnder interferometer and a second semiconductor optical amplifier is disposed on a second arm. An optical splitter splits a probe light into two portions and applies one portion to the first arm and the other to the second arm. A first optical coupler combines the probe lights output from the first and second arms. A second optical splitter splits a data light into two portions. A second optical coupler applies one output from the second optical splitter to the first arm in the backward direction. A third optical coupler applies the other output from the second optical splitter to the second arm in the forward direction.

### CROSS REFERENCE TO RELATED APPLICATIONS

This application claims priority to Japanese Patent Application No. 2003-312473, filed Sep. 4, 2004, the entire contents of which are incorporated herein by reference.

### FIELD OF THE INVENTION

This invention generally relates to an optical apparatus and an optical processing method, and more specifically relates to an optical apparatus to use two semiconductor optical amplifiers (SOA) in an interferometer configuration and an optical processing method to use such an interferometer.

### BACKGROUND OF THE INVENTION

An all-optical wavelength converter of the Mach-Zehnder interferometer (MZI) type is well known in the art, in such a converter, two SOAs are disposed on both arms of a Mach-Zehnder interferometer. There are two kinds of configurations in this type of converters. In one configuration, both a probe light and a data light are applied to an SOA on one of arms of a Mach-Zehnder interferometer and the probe light alone is applied to an SOA on the other arm of the Mach-Zehnder interferometer. In the other configuration, both a probe light and a data light are applied to an SOA on one of the arms of a Mach-Zehnder interferometer and the probe light and the data light delayed by a predetermined period are applied to an SOA on the other arm. The former is applicable to a data light of either data format of NRZ and RZ. The latter is a sort of differential-input configuration and applicable to a data light of RZ format. In both configurations, there are two ways of propagation of a data light and a probe light, namely the propagation in the same direction and the propagation in the opposite direction. The probe light is generally a continuous wave (CW) laser light.

Generally, this type of wavelength converter can be used as an optical switch to switch a probe light according to a data light and vice versa. Such wavelength converters are described in Japanese Laid-Open Patent Publication No. HEISEI 7-20510 and corresponding U.S. Pat. No. 5,535,001.

When a data light and a probe light are applied into an SOA, two phenomena occur due to the absorption of the data light; one is cross gain modulation (XGM) in which gain of the probe light varies, and the other is cross phase modulation (XPM) in which phase of the probe light varies. In order to make the separation of the data light and the probe light easy, wavelength of the probe light is generally different from that of the data light.

In a differential input configuration in which a data light and a probe light are applied to both SOAs, the XPM is used. That is, phase variation of the probe light is set to approximately π (rad) when the data light and the probe light enter both SOAs. FIG. 6 shows examples of a waveform 50 of the data light and gain variations 52, 54 and phase variations 56, 58 of the probe light on both SOAs in such a case. FIG. 7 shows an example of an output waveform 60 from a destructive port. In FIG. 7, the solid line expresses an output waveform of each port when XGM is not negligible and the broken line expresses an output waveform of each port in an ideal case that only the XPM is introduced into SOAs while the XGM does not exist.

Since the same data light is input to both SOAs at predetermined intervals, the timing of phase variation due to the XPM of the probe light output from one of the SOAs precedes by a predetermined period compared to the timing of phase variation due to the XPM of the probe light output from the other SOA. When the probe lights output from both SOAs are combined, the combined light becomes a return-to-zero (RZ) optical pulse according to the time-difference of phase variations due to the XPM in both SOAS. This RZ optical pulse carries a pulse signal being carried by the data light, or its inverted signal. As shown in FIG. 7 with a solid line, a pulse waveform of the probe light after the combination deteriorates due to the XGM when the influence of the XGM is not negligible.

The configuration for applying the data light to only one of arms or SOAs is applicable to an NRZ signal. FIG. 8 shows examples of a waveform 70 of the data light and gain variations 72, 74 and phase variations 76, 78 of the probe light in both SOAs in this case. FIG. 9 shows an example of an output waveform 80 from a destructive port and an example of an output waveform 82 from a constructive port corresponding to the waveform examples shown in FIG. 8. In FIG. 9, the solid line expresses an output waveform from each port when the XGM is not negligible and the broken line expresses an output waveform from each port in an ideal case that only the XPM is introduced into both SOAs while no XGM exists.

In this conventional configuration, although both XPM and XGM are introduced into the SOA to which the data light is applied, neither XPM nor XGM is introduced to the SOA to which the probe light alone is applied. Accordingly, it is difficult to balance the optical intensities of the probe lights output from both SOAS. Due to the unbalance of the optical intensities of the probe lights output from both SOAs, an extinction ratio and/or intensity of an output light decreases.

### SUMMARY OF THE INVENTION

According to the invention, an optical apparatus comprises a first arm having a first semiconductor optical amplifier, a second arm having a second semiconductor optical amplifier, a first optical splitter to split a probe light into two portions and to apply one portion to the fist arm and the other to the second arm, a first optical coupler to combine the probe lights output from the first and second arms, a second optical splitter to split a data light into two portions, a second optical coupler to apply one of output lights from the second optical splitter to the first arm in the backward direction, and a third optical coupler to apply the other output from the second optical splitter to the second arm in the forward direction.

According to the invention, in a Mach-Zehnder interferometer that comprises a first arm having a first semiconductor optical amplifier, a second arm having a second semiconductor optical amplifier, and a first optical splitter to split a probe light into two portions and to apply one portion to a first arm and the other to second arm, an optical processing method comprises splitting a data light into two portions, applying one portion of split data lights to the first semiconductor optical amplifier in the opposite direction to the probe light and the other portion of split data lights to the second semiconductor optical amplifier in the same direction to the probe light.

In the invention, according to the above configuration, a probe light output from the first semiconductor optical amplifier and a probe light output from the second semiconductor optical amplifier have waveforms of the almost same optical intensity variation with the relatively constant phase difference. Accordingly, it is possible to transfer a data being carried by a data light of NRZ format onto a probe light and therefore an output light having a satisfactory extinction ratio is obtained.

Preferably, the data light is applied to the first and second semiconductor optical amplifiers at the almost same timing.

Preferably, a first phase adjuster is disposed on the first arm for adjusting a phase of light propagating on the first arm. Preferably, a second phase adjuster is disposed on the second arm for adjusting a phase of light propagating on the second arm.

Preferably, an amount of phase modulation of the probe light in the first semiconductor optical amplifier differs by approximately π (rad) compared to an amount of phase modulation of the probe light in the second semiconductor optical amplifier.

This invention makes it possible to realize an all-optical wavelength converter for generating an output that is more stable and does not depend on a format of an input data light. Furthermore, pattern effects can be greatly reduced.

### BRIEF DESCRIPTION OF THE DRAWINGS

The above and other objects, features and advantages of the present invention will be apparent from the following detailed description of explanatory embodiments of the invention in conjunction with the accompanying drawings, in which:

FIG. 1 is a schematic block diagram of an explanatory embodiment according to the invention;

FIG. 2 shows an example of measured XPM amounts of the propagation in the same direction and the propagation in the opposite direction;

FIG. 3 shows examples of a waveform 40 of a data light 16 and an optical intensity waveform 42 of a probe light output from SOAs 22a and 26a;

FIG. 4 is a waveform example of a constructive interference light output from an optical coupler 32;

FIG. 5 is an output waveform example of a constructive interference in a conventional configuration in which a data light is applied to only one SOA;

FIG. 6 shows a waveform of a data light, and gain variations and phase variations of a probe light in both SOAs in a conventional apparatus of a differential input configuration;

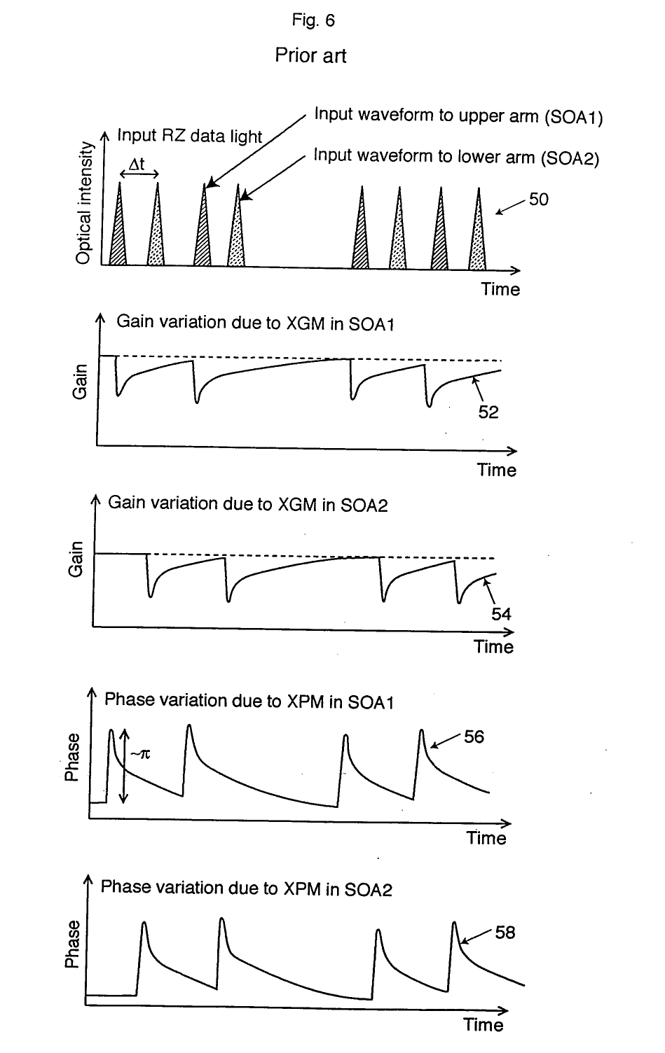

FIG. 7 is an output waveform example from a destructive port corresponding to the example shown in FIG. 6;

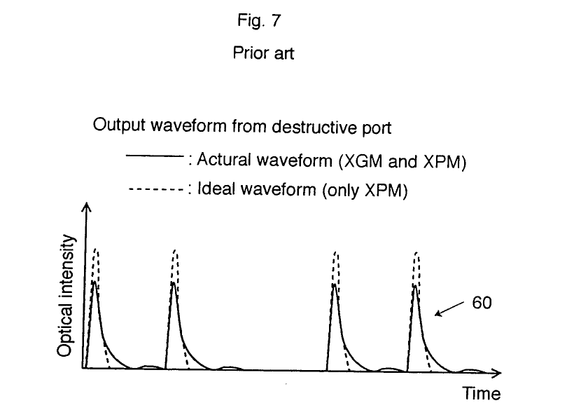

FIG. 8 shows examples of a data light waveform and gain variations and phase variations of a probe light in both SOAs; and

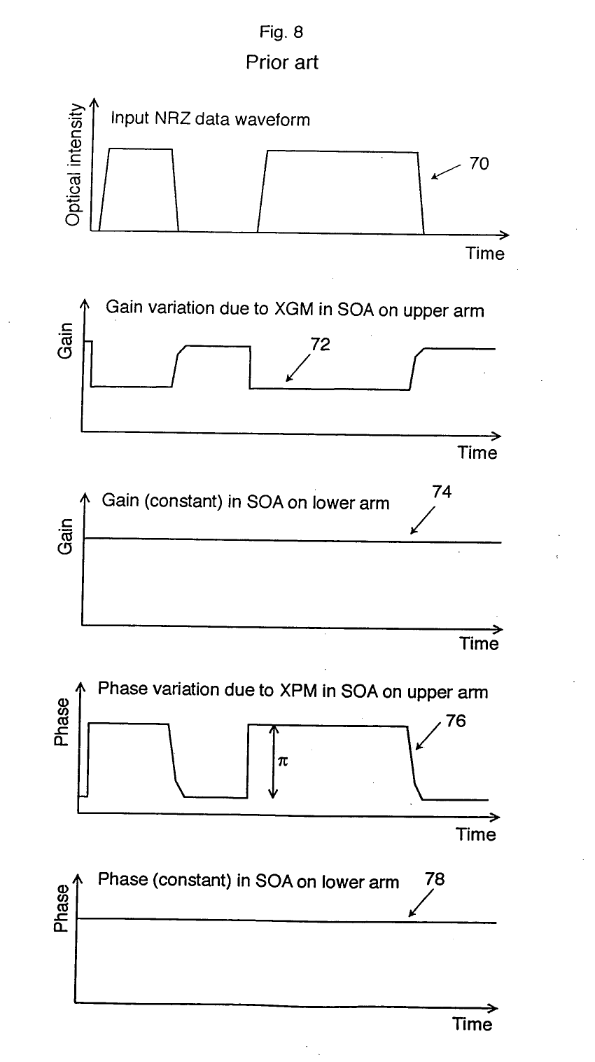

FIG. 9 shows output waveform examples from a destructive port and a constructive port corresponding to the examples shown in FIG. 8.

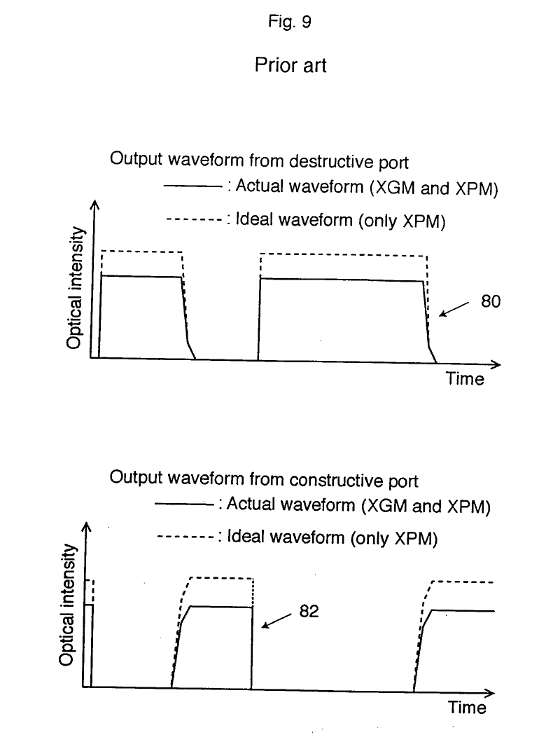

### DETAILED DESCRIPTION

Explanatory embodiments of the invention are explained below in detail with reference to the drawings. The inventors of the invention discovered that the XPM amount was greatly different when a data light and a probe light were input to an SOA in the same direction compared to a case that the data light and the probe light were input to an SOA in the opposite direction, although the XGM amount and gain recovery time showed no significant difference. This invention uses the above discovery for a SOA-MZI all-optical wavelength converter.

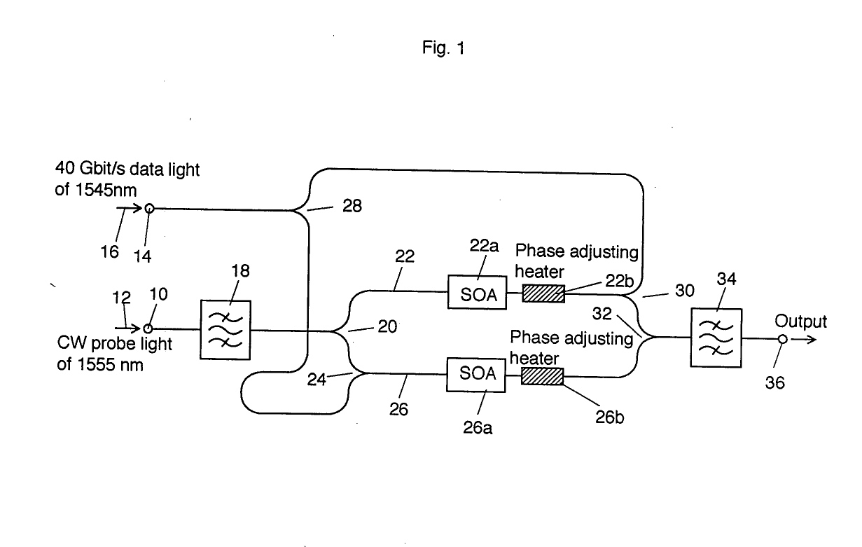

FIG. 1 shows a schematic block diagram of an explanatory embodiment according to the invention. A continuous wave (CW) probe light 12 at a wavelength of 1555 nm (λp) enters an input terminal 10. A 40 Gb/s data light 16 at a wavelength of 1545 nm (λd) enters an input terminal 14. An optical bandpass filter (OBPF) 18, its center transmission wavelength being set to a probe wavelength λp, transmits the probe light 12. An optical splitter 20 splits the probe light 12 passed through the OBPF 18 into two portions and applies one portion to a first arm 22 of a Mach-Zehnder interferometer and the other to a second arm 26 of the Mach-Zehnder interferometer via an optical coupler 24. A semiconductor optical amplifier (SOA) 22a and a phase adjusting heater 22b are disposed on the first arm 22. An SOA 26a and a phase adjusting heater 26b are disposed on the second arm 26. The split factor of the optical coupler 20 and the transmission factor of the optical coupler 24 are set to approximately 1/2 or 50%.

On the other hand, the data light 16 having entered the input terminal 14 is split to two portions by an optical splitter 28; one portion is applied to the first arm 22 via an optical coupler 30 so as to propagate in the opposite direction to the probe light and the other is applied to the second arm 26 via the optical coupler 24 so as to propagate in the same direction to the probe light. The optical path length from the optical splitter 28 to the SOA 22a via the optical coupler 30 and the heater 22b and the optical path length from the optical splitter 28 to the SOA 26a through the optical coupler 24 are controlled so that the data lights enter the SOAs 22a and 26a at the same timing. The split factor and the transmission factor of the data light in the optical splitter 28 and optical couplers 24, 30 are set to approximately 1/2 or 50%.

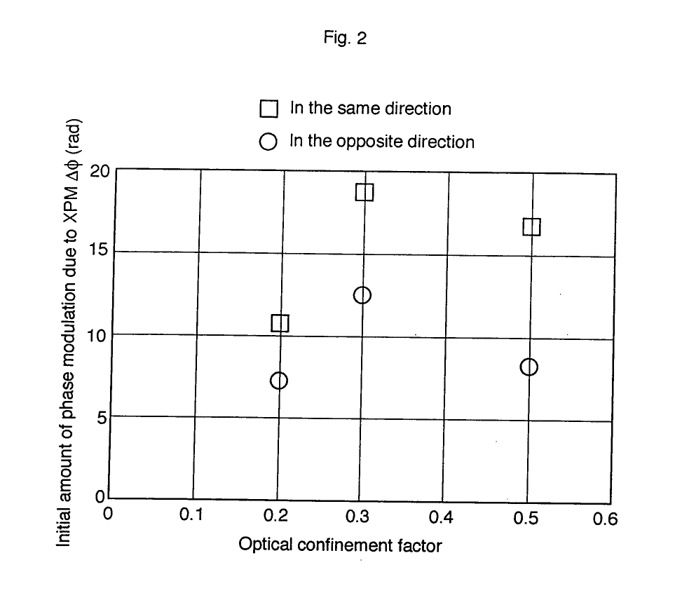

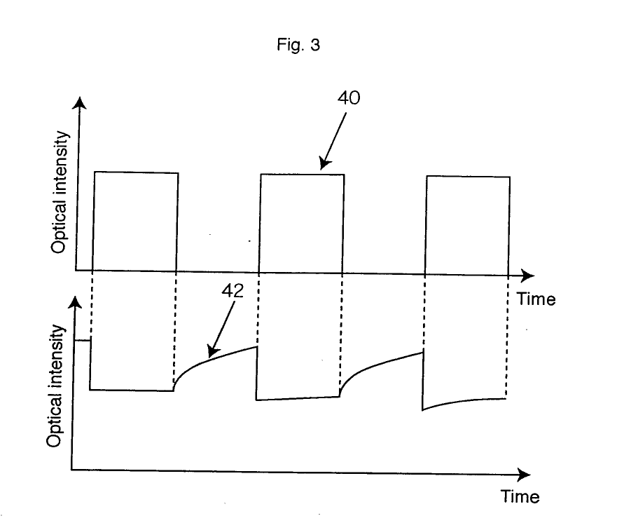

In this explanatory embodiment, with the above configuration, the probe light and the data light propagate in the opposite direction in the SOA 22a while they propagate in the same direction in the SOA 26a. As explained above, the amount of XPM in the case that the probe light and the data light propagate in the opposite direction is greatly different from that in the case that the probe light and the data light propagate in the same direction, although the amounts of XGM of both cases are almost the same. That is, as shown in FIG. 2, the amount of XPM for the incidence in the same direction approximately doubles that for the incidence in the opposite direction. In FIG. 2, the horizontal axis shows an optical confinement factor of an active layer in an SOA, and the vertical axis shows an initial phase variation Δφ (rad) due to XPM. In this embodiment, the structures, sizes and injection currents of the SOAs 22a and 26a are adjusted so that the amount of XPM of the SOA 22a becomes larger than that of the SOA 26a by about π (rad). Accordingly, although the optical intensities of the probe lights output from the SOA 22a and 26a indicate almost identical variations in the time domain, the optical phases of those probe lights differ approximately by π (rad). FIG. 3 shows a waveform 40 of the data light 16 and a waveform 42 of optical intensity of the probe light output from the SOA 22a, 26a. The horizontal axis expresses time, and the vertical axis expresses optical intensity.

The probe light output from the SOA 22a enters an optical coupler 32 via the heater 22b and the optical coupler 30. Although the optical coupler 30 transfers a portion of the input probe light to the optical coupler 28, the transferred probe light component is not used. The probe light output from the SOA 26a enters the optical coupler 32 via the heater 26b. The slight difference of the optical path length (optical phase) between the arms 22 and 26 is adjusted by the heater 26b. Accordingly, the two probe lights, their phase differences being approximately π (rad) and their optical intensities being almost identical, enter the optical coupler 32. The optical coupler 32 couples the input two probe lights so as to interfere with each other. An optical band pass filter 34, its center wavelength being set to a probe wavelength λp, transmits the probe light coupled by the optical coupler 32. An output light from the optical bandpass filter 34 is output for the outside through an output terminal 36.

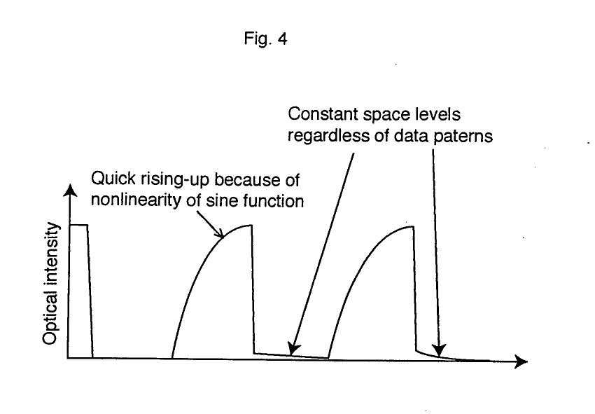

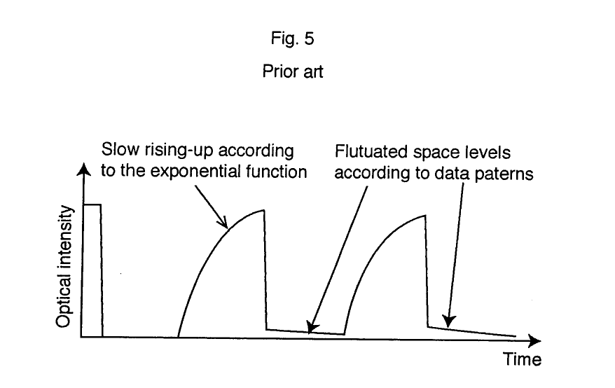

FIG. 4 shows a waveform example of a constructive interference light output from the optical coupler 32. The horizontal axis expresses time, and the vertical axis expresses optical intensity. For reference, FIG. 5 shows a waveform of a constructive interference output in a conventional configuration in which a data light is input to only one of SOAs. In FIG. 5, the horizontal axis expresses time, and the vertical axis expresses optical intensity. In this specification, such state that a probe light is being output when no data light exists is expressed as “constructive”, and such state that a probe light is not being output when no data light exists is expressed as “destructive”.

Since an SOA has limited gain recovery time, gain recovers slowly as a waveform of a data light transits from “1” (mark) level to “0” (space) level. This causes deterioration of a waveform of an output pulse. In this embodiment, a gain relative to a probe light varies in the same way in the SOAs 22a and 26a and accordingly a waveform during the level transition is exclusively affected by the difference of the optical phase recovery between the SOAs. In the conventional method, an optical pulse rises up slowly because two differences of the optical intensity recovery and the optical phase recovery affect an output waveform together. However, in this embodiment, only the optical phase recovery affects an output waveform and accordingly an optical pulse rises up much steeply.

In the conventional configuration, there is a problem of pattern effects. Namely, in a conventional configuration that inputs a data light to two SOAs with a time lag, fluctuation of an output waveform at space levels becomes larger when mark levels of an input data light are repeated at short intervals because both of the optical intensity difference and the optical phase difference between arms have pattern dependency. On the other hand, in this embodiment, there is no difference in the optical intensity between the two arms and only the predetermined optical phase difference, i.e. approximately π (rad), exists and therefore it is possible to obtain output space levels of almost constant intensity with no influence of residual phase difference. In this embodiment, the phase modulation efficiency for optical power of an input data light reduces compared to a conventional system because the difference between the amounts of phase modulation in both arms is utilized. However, the above-mentioned merits more than make up for this demerit.

In this embodiment, an output optical pulse quickly rises up because of nonlinearity of the sine function. However, in a conventional system, an output optical pulse slowly rises up according to the exponential function. As mentioned above, in this embodiment, the variation of optical intensity is stable regardless of a data pattern. However, in a conventional system, the variation of optical intensity fluctuates according to a data pattern. That is, in this embodiment, rising-up of a pulse is improved and pattern effects are reduced at the space level.

The data light not absorbed by the SOA 22a enters the optical bandpass filter 18 via the optical coupler 20. Since the bandpass filter 18 absorbs a data light, the data light not absorbed by the SOA 22a cannot arrive the input terminal 10. It is possible to replace the optical bandpass filter 18 with an optical isolator for transmitting the probe light.

The wavelengths of the data light and probe light described above are only examples of many. The wavelength of data light may be the wavelength in the gain band of SOA 22a, 26a. Regarding to a wavelength of a probe light, it is satisfactory as far as it is capable of receiving XPM in the SOAs 22a and 26a.

Although the operation that converts a data carried by a data light into another wavelength (probe wavelength λp) has been explained, it is possible to use this embodiment as an optical switch by replacing the probe light with a pulse light of RZ format and the data light with a switch control light. Furthermore, when the probe light is a signal light for carrying another data, this embodiment can be used as an optical arithmetic unit that operates a data to be carried by the data light and a data to be carried by the probe light in the optical state.

While the invention has been described with reference to the specific embodiment, it will be apparent to those skilled in the art that various changes and modifications can be made to the specific embodiment without departing from the spirit and scope of the invention as defined in the claims.

1. An optical apparatus comprising:
a first arm having a first semiconductor optical amplifier;
a second arm having a second semiconductor optical amplifier;
a first optical splitter to split a probe light into first and second probe light portions and to apply the first probe light portion to the first arm and the second probe light portion to the second arm;
a first optical coupler to combine the first and second probe light portions output from the first and second arms;
a second optical splitter to split a data light into first and second data light portions;
a second optical coupler to apply the first data light portion output from the second optical splitter to the first arm in a backward direction; and
a third optical coupler to apply the second data light portion output from the second optical splitter to the second arm in a forward direction.

2. The apparatus of claim 1 wherein the data light enters the first and second semiconductor optical amplifiers at approximately the same timing.

3. The apparatus of claim 1 or 2 wherein the first arm comprises a first phase adjuster.

4. The apparatus of claim 1 wherein the second arm comprises a second phase adjuster.

5. The apparatus of claim 1 wherein an amount of phase modulation of the probe light in the first semiconductor optical amplifier differs by approximately π as compared to an amount of phase modulation of the probe light in the second semiconductor optical amplifier.

6. An optical processing method in a Mach-Zehnder interferometer that comprises a first arm having a first semiconductor optical amplifier, a second arm having a second semiconductor optical amplifier, a first optical splitter to split a probe light into two portions and to apply one portion to the first arm and the other portion to the second arm, and a first optical coupler to combine the two portions of the probe light outputted from the first and second arms, the optical processing method comprising:
splitting a data light into first and second portions;
applying the first portion of the data light to the first semiconductor optical amplifier in an opposite direction to the probe light; and
applying the second portion of the data light to the second semiconductor optical amplifier in a same direction to the probe light.

7. The method of claim 6 wherein the first and second portions of the data light respectively enter the first and second semiconductor optical amplifiers at approximately the same timing.

8. The method of claim 6 further comprising adjusting phase of the light that propagates on the first arm with a first phase adjuster disposed on the first arm.

9. The method of claim 6 or 8 further comprising adjusting phase of the light that propagates on the second arm with a second phase adjuster disposed on the second arm.

10. The method of claim 6 wherein an amount of phase modulation of the probe light in the first semiconductor optical amplifier differs by approximately π (rad) as compared to an amount of phase modulation of the probe light in the second semiconductor optical amplifier.

11. The apparatus of claim 1 wherein the first arm comprises a first phase adjuster and the second arm comprises a second phase adjuster.

12. An optical apparatus comprising:
means for having a first semiconductor optical amplifier;
means for having a second semiconductor optical amplifier;
means for splitting a probe light into first and second probe light portions and for applying the first probe light portion to the first semiconductor optical amplifier and the second probe light portion to the second semiconductor optical amplifier;
means for combining the first and second probe light portions outputted from the first and second semiconductor optical amplifiers;
means for splitting a data light into first and second data light portions;
means for applying the first data light portion to the first probe light portion in a backward direction; and
means for applying the second data light portion to the second probe light portion in a forward direction.

13. The apparatus of claim 12 wherein the data light enters the first and second semiconductor optical amplifiers at approximately the same timing.

14. The apparatus of claim 12 wherein an amount of phase modulation of the probe light in the first semiconductor optical amplifier differs by approximately π as compared to an amount of phase modulation of the probe light in the second semiconductor optical amplifier.

15. An optical apparatus in an interferometer that comprises a first arm having a first semiconductor optical amplifier, a second arm having a second semiconductor optical amplifier, a first optical splitter to split a probe light into two portions and to apply one portion to the first arm and another portion to the second arm, and a first optical coupler to combine the two portions of the probe light outputted from the first and second arms, the optical apparatus comprising:
means for splitting a data light into first and second portions;
means for applying the first portion of the data light to the first semiconductor optical amplifier in an opposite direction to the probe light; and
means for applying the second portion of the data light to the second semiconductor optical amplifier in a same direction to the probe light.

16. The apparatus of claim 15 wherein the first and second portions of the data light respectively enter the first and second semiconductor optical amplifiers at approximately the same timing.

17. The apparatus of claim 15 further comprising means for adjusting phase of the light that propagates on the first arm with a first phase adjuster disposed on the first arm.

18. The apparatus of claim 17 further comprising means for adjusting phase of the light that propagates on the second arm with a second phase adjuster disposed on the second arm.

19. The apparatus of claim 15 wherein an amount of phase modulation of the probe light in the first semiconductor optical amplifier differs by approximately π as compared to an amount of phase modulation of the probe light in the second semiconductor optical amplifier.
